(19) United States
(12) Patent Application Publication
(10) Pub. No.: US 2010/0254876 A1
(43) Pub. Date: Oct. 7, 2010

(54) FLAKES HYDROPHOBIC THROUGH-AND-THROUGH AND COMPRISING PYROGENICALLY PREPARED SILICON DIOXIDE

(75) Inventors: Florian Felix Kneisel, Essen (DE); Andreas Garbatscheck, Hainburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/742,258

(22) PCT Filed: Nov. 18, 2008
(86) PCT No.: PCT/EP2008/065777

§ 371 Date: May 11, 2010

(30) Foreign Application Priority Data
Dec. 12, 2007 (DE) 10 2007 059 862.0

(51) Int. Cl. C01B 33/12; B29B 15/00

(52) U.S. Cl. 423/335; 264/134

(57) ABSTRACT

Hydrophobic flakes comprising pyrogenically prepared silicon dioxide prepared by optionally mixing pyrogenically prepared silicon dioxide with water or another reaction auxiliary and a water repellent, compacting and, optionally after ripening, annealing. The hydrophobic flakes thus produced can be used as a filler in natural rubber and synthetic rubber.

The invention relates to granules or compact materials hydrophobic through-and-through and comprising pyrogenically prepared silicon dioxide, a process for their production and use thereof.

It is known that flakes can be produced from pyrogenically prepared silicon dioxide by partly dearating pyrogenically prepared silicon dioxide, which is present as a loose heap of nanoscale, highly agglomerated particles, by reduced atmospheric pressure, mechanically precompacting said silicon dioxide and finally compacting it to give flakes. These flakes can then be crushed and the fragments optionally classified (EP 1 813 574 A1).

Hydrophilic and also hydrophobic, pyrogenically prepared silicon dioxide particles can be used as starting materials. The silicon dioxide may have been rendered hydrophobic inter alia with silazanes of the type

R′R₂Si—N—SiR₂R′

H.

A disadvantage of the known process is found in the case of particles which have a high specific surface area, measured by nitrogen adsorption (BET), and simultaneously a high hydrophobicity, measured by wetting with methanol-water mixtures of graded methanol content (Corning Glass), in that these particles have a very high fluidity, so that the process according to EP 1 813 574 A1 is truly uneconomical for compacting such particles.

Fluidity is to be understood as meaning that the loose heap which is formed by agglomeration of highly aggregated particles and consists of more than 95 percent of its volume of air and only of less than 5 percent of its volume of solid is orthogonally deflected under the action of a compressive force applied from outside, it being possible for said heap also to escape through very small gaps in the same manner as a low-viscosity liquid. The flakes of hydrophobic silicon dioxides can therefore be produced only with difficulty by the process described in EP 1 813 574 A1.

In many cases, very high pressures, very long pressure dwell times and often numerous compacting cycles have to be implemented in the compacting of hydrophobic silicon dioxides. Silicon dioxides which both consist of very fine particles and are additionally strongly hydrophobic consequently cannot be compressed economically by the process described to give compact materials.

It was therefore the object to prepare hydrophobic, compact silicon dioxide which does not have these disadvantages but is homogeneously water-repellent even in the interior of the volume of the compact material, i.e. is hydrophobic through-and-through.

The invention relates to granules or compact materials based on pyrogenically prepared silicon dioxide, which are characterized in that they are water-repellent through-and-through.

The products may be present as flakes or in other compressed or granulated forms.

The invention furthermore relates to a process for the production of the flakes according to the invention which are hydrophobic through-and-through and comprise pyrogenically prepared silicon dioxide, which is characterized in that hydrophilic, pyrogenically prepared silicon dioxide is optionally first sprayed with water or another reaction auxiliary, i.e. for example dilute acid or base solution, i.e. for example dilute hydrochloric acid or ammonia, this mixture is then brought into contact with a water repellent by spraying, this mixture is then compressed to give flakes and these flakes are then allowed to ripen, optionally at a temperature of 10 to 80° C., preferably 20 to 40° C., over a period of up to a few days or weeks, in order then to anneal at a temperature of 80 to 140° C., preferably 100 to 130° C., over a period of up to 8 hours.

HMDS (hexamethyldisilazane) can preferably be used as the water repellent.

One or more compounds from the following group can furthermore be used as water repellents:
a) Organosilanes of the type (RO)₃Si(CₙH₂ₙ₊₁) and (RO)₃Si(CₙH₂ₙ₋₁)
   R=alkyl, such as, for example, methyl-, ethyl-, n-propyl-, isopropyl-, butyl-
   n=1-20
b) Organosilanes of the type R′ₓ(RO)_{y}Si(CₙH₂ₙ₊₁) and R′ₓ(RO)_{y}Si(CₙH₂ₙ₋₁)
   R=alkyl, such as, for example, methyl-, ethyl-, n-propyl-, isopropyl-, butyl-
   R′=alkyl, such as, for example, methyl-, ethyl-, n-propyl-, isopropyl-, butyl-
   R′=cycloalkyl
   n=1-20
   x+y=3
   x=1.2
   y=1.2
c) Haloorganosilanes of the type X₃Si(CₙH₂ₙ₊₁) and X₃Si(CₙH₂ₙ₋₁)
   X=Cl, Br
   n=1-20
d) Haloorganosilanes of the type X₂(R′)Si(CₙH₂ₙ₊₁) and X₂(R′)Si(CₙH₂ₙ₋₁)
   X=Cl, Br
   R′=alkyl, such as, for example, methyl-, ethyl-, n-propyl-, isopropyl-, butyl-
   R′=cycloalkyl
   n=1-20
e) Haloorganosilanes of the type X(R′)₂Si(CₙH₂ₙ₊₁) and X(R′)₂Si(CₙH₂ₙ₋₁)
   X=Cl, Br
   R′=alkyl, such as, for example, methyl-, ethyl-, n-propyl-, isopropyl-, butyl-
   R′=cycloalkyl
   n=1-20
f) Organosilanes of the type (RO)₃Si(CH₂)ₘ—R′
   R=alkyl, such as methyl-, ethyl-, propyl-
   m=0.1-20
   R′=methyl-, aryl (for example —C₆H₅, substituted phenyl radicals)
      —C₄F₉, OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be alkyl, such as methyl-, ethyl-, propyl-, butyl-
      —SH
      —NR′R″R′″ (R′=alkyl, aryl; R″=H, alkyl, aryl; R′″=H, alkyl, aryl, benzyl, C₂H₄NR″″ with R″″=A, alkyl and R′″″=H, alkyl)
g) Organosilanes of the type (R″)ₓ(RO)_{y}Si(CH₂)ₘ—R′
   R″=alkyl
      x+y=2
   =cycloalkyl
      x=1.2
      y=1.2
      m=0.1 to 20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be methyl-, ethyl-, propyl-, butyl-
      —SH
      —NR′R″R′″ (R′=alkyl, aryl; R″=H, alkyl, aryl; R′″=H, alkyl, aryl, benzyl, C₂H₄NR″″R′″″ with R″″=A, alkyl and R′″″=H, alkyl)
h) Haloorganosilanes of the type X₃Si(CH₂)ₘ—R′
   X=Cl, Br
   m=0.1-20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂,
      —NH—CH₂—CH₂—NH₂
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be methyl-, ethyl-, propyl-, butyl-
      —SH
i) Haloorganosilanes of the type (R)X₂Si(CH₂)ₘ—R′
   X=Cl, Br
   R=alkyl, such as methyl-, ethyl-, propyl-
   m=0.1-20
   R′=methyl-, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃,
      where R may be methyl-, ethyl-, propyl-, butyl-
      —Sₓ—(CH₂)₃Si(OR)₃, where R may be methyl-, ethyl-, propyl-, butyl- and X may be 1 to 10
      —SH
j) Haloorganosilanes of the type (R)₂X Si(CH₂)ₘ—R′
   X=Cl, Br
   R=alkyl, such as methyl-, ethyl-, propyl-, butyl-
   m=0.1-20
   R′=methyl-, aryl (e.g. —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃, where X=1 to 10 and
      R may be methyl-, ethyl-, propyl-, butyl-
      —SH
k) Silazanes of the type

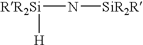

R=alkyl
R′=alkyl, vinyl
l) Cyclic polysiloxanes of the type D 3, D 4, D 5, where D 3, D 4 and D 5 are understood as meaning cyclic polysiloxanes having 3,4 or 5 units of the type —O—Si(CH₃)₂—,
   e.g. octamethylcyclotetrasiloxane=D 4

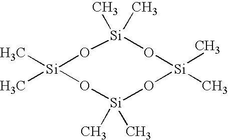

m) Polysiloxanes or silicone oils of the type

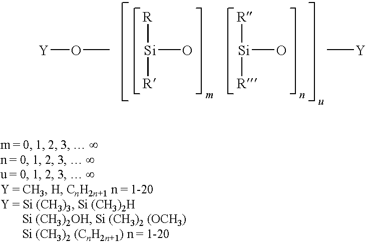

R=alkyl, such as CₙH₂ₙ₊₁, where n is 1 to 20, aryl, such as
phenyl and substituted phenyl radicals, (CH₂)ₙ—NH₂, H

R′=alkyl, such as CₙH₂ₙ₊₁, where n is 1 to 20, aryl, such as
phenyl and substituted phenyl radicals, (CH₂)ₙ—NH₂, H

R″=alkyl, such as CₙH₂ₙ₊₁, where n is 1 to 20, aryl, such as
phenyl and substituted phenyl radicals, (CH₂)ₙ—NH₂, H

R′″=alkyl, such as CₙH₂ₙ₊₁, where n is 1 to 20, aryl, such as
phenyl and substituted phenyl radicals, (CH₂)ₙ—NH₂, H

A hydrophilic, pyrogenically prepared silicon dioxide having the following physical chemical characteristics can be used as starting material:

| | |
|---|---|
| BET surface area: | 30-400 m²/g |
| Tamped density: | 40-200 g/l |
| Mean primary particle size: | 5-50 nm |

The initially obtained flakes hydrophobic through-and-through can subsequently be crushed or otherwise comminuted and the fragments sieved, sifted or otherwise classified.

It is a low-dust to dust-free dosage form of a corresponding hydrophobic silicon dioxide. The flakes according to the invention are also distinguished by a substantially increased tamped density, which is associated with a small packing volume.

The flakes according to the invention can be used as a filler in natural rubber and synthetic rubber.

### EXAMPLES

The hydrophilic, pyrogenically prepared silicon dioxide AEROSIL® 300 is used as starting material.

It has the following physical chemical characteristics:

| | Unit | |
|---|---|---|
| Specific surface area | m²/g | 300 ± 30 |
| (BET) | | |
| Mean size of the primary | nm | 7 |
| particles | | |
| Tamped density (approx. | g/l | About 50 |
| value)* | | |
| based on DIN EN ISO | | |
| 787/11, August 1983 | | |
| Loss on drying* | % by weight | <1.5 |
| 2 h at 105° C. | | |
| Loss on ignition | % by weight | <2.0 |
| 2 h at 1000° C., based on | | |
| the dried substance (2 h | | |
| at 105° C.) | | |
| pH value | | 3.7-4.7 |
| 4% strength dispersion | | |
| SiO₂ content, based on the | % by weight | >99.8 |
| ignited substance | | |

HMDS (hexamethyldisilazane) was used as a water repellent.

AEROSIL® 300 was optionally first sprayed or otherwise mixed with water or another auxiliary, such as, for example, dilute acid or base solution, i.e. for example dilute hydrochloric acid or ammonia, and this mixture is then mixed homogeneously with HMDS by spraying. The mixture was then pressed as far as possible without delay in a roll compacter to give flakes.

Table 1 shows the preparation of the reaction mixture.

Table 2 shows the data of the compacting step.

The flakes according to example 1 were annealed for 3 h at 110° C. and the flakes according to example 2 were annealed for 6 h at 110° C.

Table 3 shows the physical chemical data of the hydrophobic flakes according to the invention comprising pyrogenically prepared silicon dioxide.

TABLE 1
Mixing ratios AEROSIL ® 300/water/HMDS for the
individual experiments

| | Amount of | Amount of | Amount of |
|---|---|---|---|
| | AEROSIL ® 300 | water | HMDS |
| Example | [kg] | [kg] | [kg] |
| 1 | 12.0 | 0.6 | 2.4 |
| 2 | 12.0 | 2.4 | 2.4 |

TABLE 2
Process parameters for the compacting

| | | | | Metering | | | |
|---|---|---|---|---|---|---|---|
| | | Specific | | speed for | | | |
| | | roll | Speed of | starting | Ripening | | |
| | No. of | pressure | metering | materials | time | | Tamped |
| Example | compacting | [kN/cm] | screw [rpm] | [kg/h] | [h] | Product form | density [g/l] |
| 1 | 1/3 | 2 | 98 | 5.0 | 3.0 | Powder | ~220 |
| | 2/3 | 6 | 35 | 5.0 | 5.5 | Powder | ~420 |
| | 3/3 | 7 | 20 | 5.0 | 8.0 | Powder with | ~490 |
| | | | | | | granulated | |
| | | | | | | flakes | |
| 2 | 1/2 | 1 | 98 | 6.3 | 0.5 | Powder | ~310 |
| | 2/2 | 7 | 30 | 7.8 | 3.0 | Granulated | ~560 |
| | | | | | | flakes having a | |
| | | | | | | small fines fraction | |

Physical Chemical Data:

TABLE 3
Physical chemical data of the flakes according to the invention

| | | | | C | C | | | | | | |
|---|---|---|---|---|---|---|---|---|---|---|---|
| | | | | content | content | | Loss on | Loss on | | Bulk | Tamped |
| | pH | pH | Sears | (before ex.) | (after ex.) | DBP | drying | ignition | Product | density | density |
| Example | (DIN) | (Sears) | number | [%] | [%] | number | [%] | [%] | form | [g/l] | [g/l] |
| 1 | 8.8 | 8.5 | 1.4 | 3.6 | 3.5 | 96 | 0.1 | 3.7 | Powder/ | ~400 | ~480 |
| | | | | | | | | | flakes | | |
| 2 | 8.2 | 8.4 | 1.0 | 4.9 | 4.0 | 83 | 0.6 | 5.3 | Powder/ | ~400 | ~480 |
| | | | | | | | | | flakes | | |

1. Flakes comprising pyrogenically prepared silicon dioxide, characterized in that they are homogeneous, i.e. water-repellent through-and-through.

2. Process for the production of flakes comprising pyrogenically prepared silicon dioxide according to claim 1, characterized in that hydrophilic, pyrogenically prepared silicon dioxide is optionally first sprayed with water or another reaction auxiliary and this mixture is then brought into contact with a water repellent by spraying, this mixture is then pressed to give flakes and these flakes are then optionally allowed to ripen at a temperature of 10 to 80° C. and then annealed at a temperature of 80 to 140° C.

3. Use of the flakes according to claim 1 as a filler in natural rubber and synthetic rubber.
